(19) United States
(12) Patent Application Publication
(10) Pub. No.: US 2026/0081879 A1
(43) Pub. Date: Mar. 19, 2026

(54) VIRTUAL CHANNEL PACKET PROCESSING IN DIGITAL INTERFACES

(71) Applicant: NVIDIA Corporation, Santa Clara, CA (US)

(72) Inventors: Naveen Kumar Narrishetti, Narsampet (IN); Sathyanarayan Balaji, Bangalore (IN)

(21) Appl. No.: 18/888,621

(22) Filed: Sep. 18, 2024

(51) Int. Cl. H04L 49/90

(52) U.S. Cl. CPC H04L 49/9084; H04L 49/9036

(57) ABSTRACT

A buffer management system receives packet data associated with a first packet characteristic of a plurality of packet characteristics of a plurality of packets transmitted via a digital interface. The packet data is stored in a first input accumulator of a plurality of input accumulators of the buffer management system. The first input accumulator corresponds to the first packet characteristic. A threshold quantity of packet data is obtained from the first input accumulator responsive to determining that the threshold quantity of packet data is accumulated in the first input accumulator. The threshold quantity of packet data is stored in a line of a shared buffer for the plurality of packets transmitted via the digital interface. The shared buffer is associated with the plurality of packet characteristics.

### TECHNICAL FIELD

Aspects and embodiments of the present disclosure relate to data transfer in computer systems, and in particular to virtual channel packet processing in digital interfaces.

### BACKGROUND

Computer systems often include digital interfaces to enable links between component devices of the computer systems. For example, the Peripheral Component Interconnect Express (PCIe) digital interface can be used to link peripheral devices such as network interface controllers (NICs), graphical processing units (GPUs), or storage devices to each other or to a central processing unit (CPU). Other examples of digital interfaces include Compute Express Link (CXL), Double Data Rate (DDR) interface, Universal Serial Bus (USB), and similar.

### BRIEF DESCRIPTION OF DRAWINGS

Various embodiments in accordance with the present disclosure will be described with reference to the drawings, in which:

FIG. 1A is a block diagram of an example system architecture for providing virtual channel packet processing in digital interfaces, in accordance with an embodiment;

FIG. 1B is a block diagram of an example digital interface controller architecture for providing virtual channel packet processing in digital interfaces, in accordance with an embodiment;

FIG. 1C is a block diagram of an example digital interface controller architecture for providing virtual channel packet processing in digital interfaces, in accordance with an embodiment

FIG. 2 is a block diagram of an example buffer for providing virtual channel packet processing in digital interfaces, in accordance with an embodiment;

FIG. 3 is a block diagram of an example mapping between packet data and buffer lines, in accordance with an embodiment;

FIG. 4A is a flow diagram of an example method for providing virtual channel packet processing in digital interfaces, in accordance with an embodiment;

FIG. 4B is a flow diagram of an example method for providing storing a threshold quantity of packet data in a shared buffer using a write pointer, in accordance with an embodiment; and

FIG. 5 illustrates an example computer system, in accordance with an embodiment.

### DETAILED DESCRIPTION

Aspects of the present disclosure relate to virtual channel packet processing in digital interfaces. Computer systems can face challenges related to efficiently managing packet buffers for multiple virtual channels and multiple packet types of a digital interface link. Computer systems often include digital interfaces to enable links between component devices of the computer systems. For example, the Peripheral Component Interconnect Express (PCIe) digital interface can be used to link peripheral devices such as network interface controllers (NICs), graphical processing units (GPUs), or storage devices to each other or to a central processing unit (CPU). Other examples of digital interfaces include Compute Express Link (CXL), Double Data Rate (DDR) interface, Universal Serial Bus (USB), and similar. A component device connected via a digital interface link can include receive-side buffers to collect data incoming on the link before passing the data to other hardware or software modules of the device.

Some digital interfaces can support multiple virtual channels over a single link. For example, PCIe can support up to eight virtual channels VC0 through VC7. A virtual channel can enable traffic of different priorities to be routed across the link according to priority. Some digital interfaces can also support packetized data and different types of packets. For example, PCIe defines posted (P), non-posted (NP), and completion (Cpl) packet types. A digital interface can include a credit system for different packet types and/or different virtual channels to enable flow control over the link.

The above-described systems can face several challenges relating to buffering data in digital interface receivers. Among these challenges are: (i) buffer size requirements for multiple virtual channels and packet types, and (ii) fragmentation in shared buffers. These challenges are further described below.

First, systems can allocate excessive silicon area and excessive power to independent buffers for different virtual channels and/or packet types. Each buffer can be sized for covering the worst-case round-trip latency of the link and can be duplicated for each virtual channel and/or packet type. However, the duplicate buffers are generally not filled to capacity simultaneously, leading to wasted silicon area and power resources across the collection of buffers. Some shared buffer architectures, such as a multi-port SRAM, enable virtual channels and/or packet types to share SRAM resources while having dedicated SRAM ports. However, such architectures suffer from similar silicon area resource requirements.

Second, systems can experience fragmentation of packets when using shared buffer architectures. For example, as smaller packets of one virtual channel are removed from a buffer, thereby freeing up non-contiguous spaces in the buffer, larger incoming packets of another virtual channel may be fragmented to fit into the recently freed non-contiguous spaces. Thus, these systems would need to devote additional resources to tracking and managing fragmented packets in the shared buffer.

As a result of these challenges, system manufacture and operational costs can be increased due to the various silicon, power, and other resource requirements described above. Furthermore, designing such systems to manage packet fragmentation can be error prone and can introduce additional latency in packet processing.

Aspects of the present disclosure address the above challenges and other challenges by providing buffer management systems that enable out-of-order packet processing and shared buffers without fragmentation. An example system can include one or more of the following components: (i) a shared buffer providing fixed-width data transactions that are tracked with linked lists for each virtual channel and/or packet type, (ii) fixed-width input and output accumulators for each virtual channel and/or packet type, and (iii) a buffer manager for coordinating transfer of data between a shared buffer and input/output accumulators. Some embodiments of these components are further described below.

In an embodiment, a buffer management system includes a shared buffer that can store packets associated with different virtual channels and/or packet types. The shared buffer includes multiple fixed-width lines for storing packet data of a fixed data width and associated buffer metadata. The shared buffer further includes a pointer management component for storing and updating read and write pointers for each virtual channel and/or packet type. The pointer management component and the buffer metadata can be used to form interleaved linked lists of packet data for each virtual channel and/or packet type. For example, when a read pointer for one virtual channel is accessed and the corresponding line is retrieved and removed from the buffer, a write pointer for a second virtual channel can be updated to point to the now-available line.

In an embodiment, a buffer management system includes fixed-width input and/or output accumulators. The width of the input and output accumulators can correspond to a fixed data width of a shared buffer. Each virtual channel and/or packet type can be associated with unique input/output accumulators. An input accumulator for a given virtual channel and/or packet type can accumulate variable-width packet data and provide fixed-width increments of the packet data for storage in a shared buffer. Similarly, an output accumulator for a given virtual channel and/or packet type can accumulate fixed-width increments of packet data from a shared buffer and provide individual variable-width packets to subsequent hardware or software components.

In an embodiment, a buffer management system includes a buffer manager for coordinating transfer of fixed-width data between a shared buffer and input/output accumulators. The buffer manager can determine when a full fixed-width segment of packet data is available in an input accumulator and can provide the segment to the shared buffer for storage. Similarly, the buffer manager can determine when space is available in an output accumulator and can retrieve a fixed-width segment of packet data from the buffer for the output accumulator.

Accordingly, buffer management systems using these techniques can have reduced manufacture and operational costs. Furthermore, system design complexity can be reduced and packet processing fragmentation and latency can be reduced.

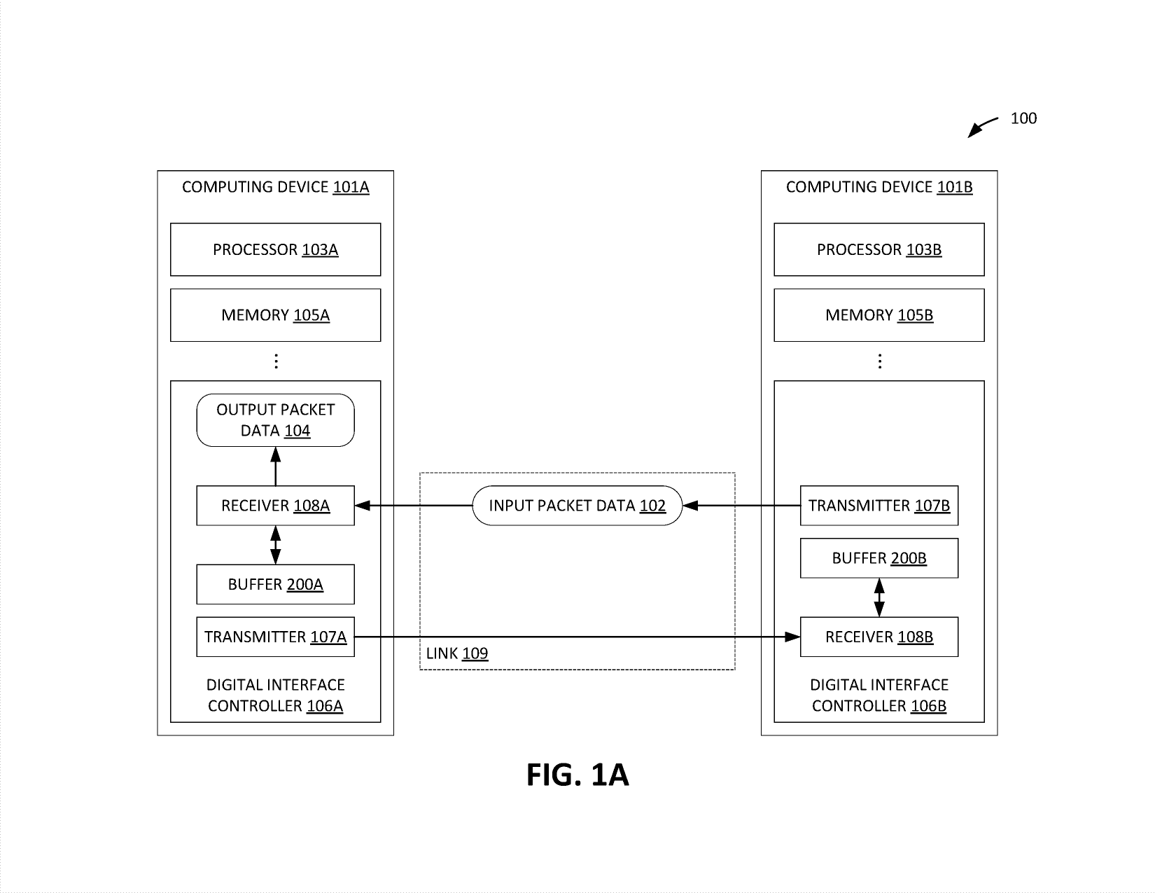

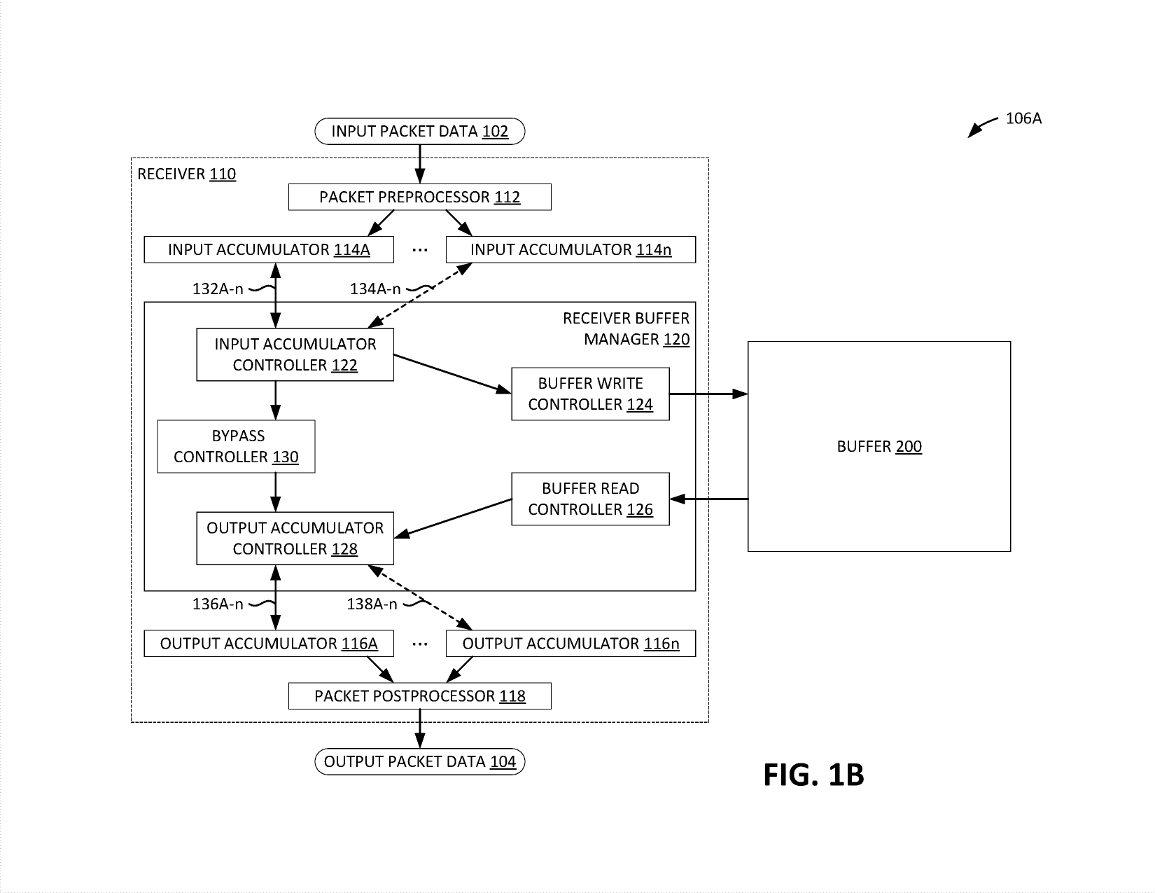

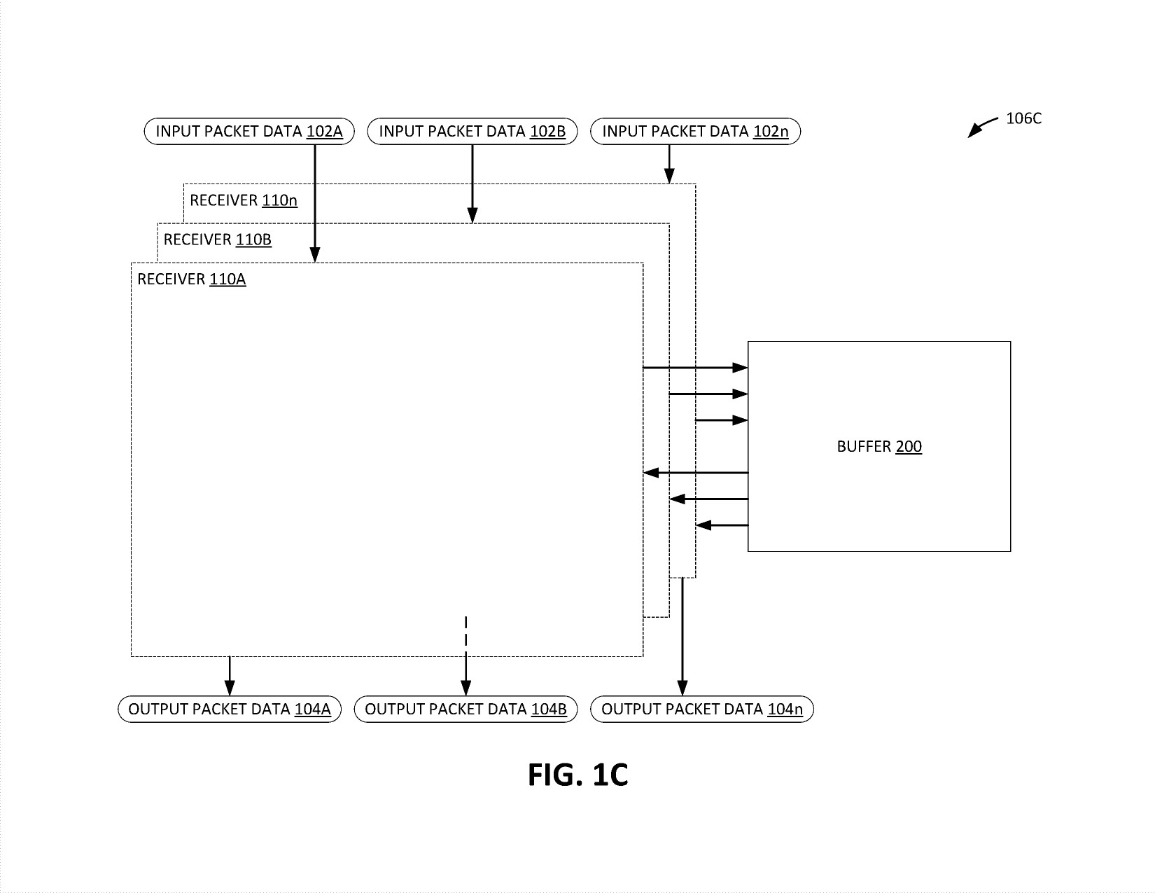

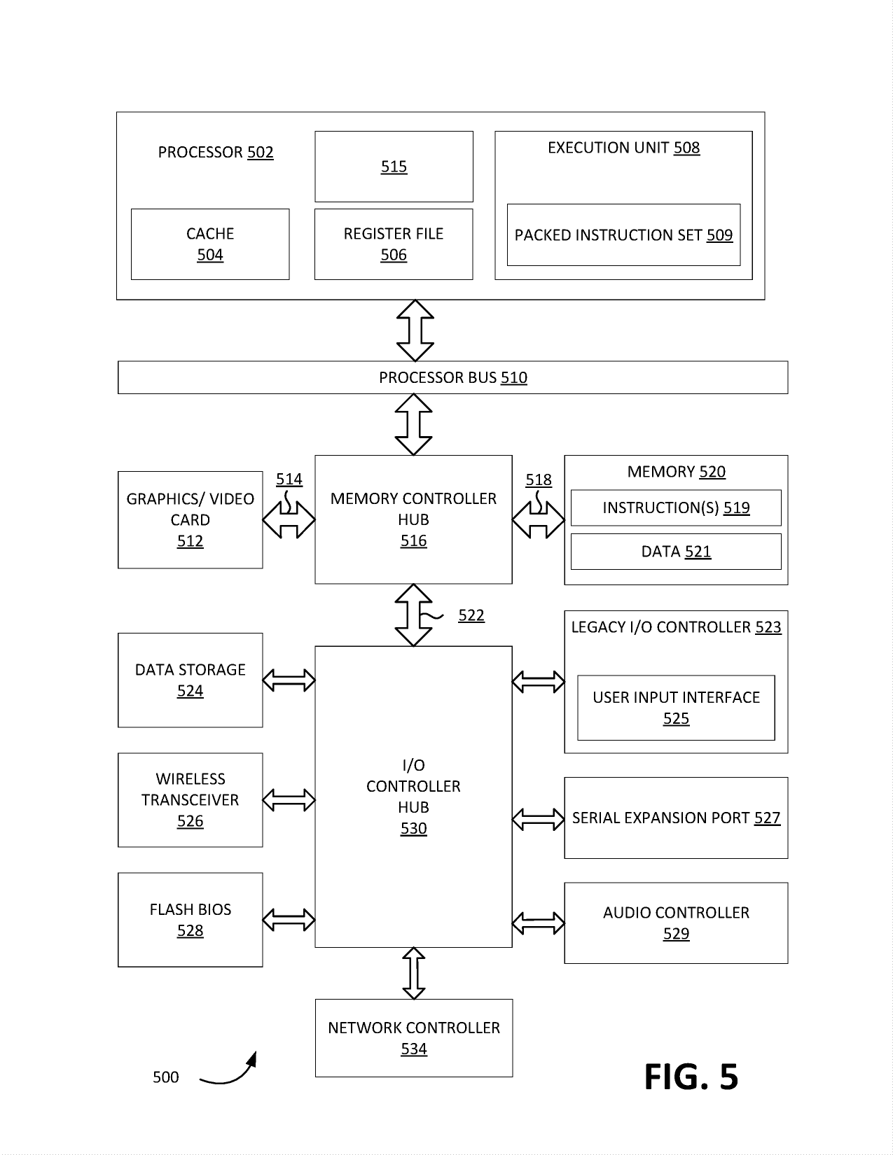

FIG. 1A is a block diagram of an example system architecture 100 for providing virtual channel packet processing in digital interfaces, in accordance with an embodiment. System architecture 100 (also referred to as “system” herein) includes computing devices 101A-B connected by digital interface link 109. Computing device 101A includes processor 103A, memory 105A, digital interface controller 106A, and other components. Computing device 101B includes similar components. In various embodiments, computing devices 101A-B can include more, fewer, or different components than those depicted in FIG. 1A. For example, computing device 101A can include storage, other input/output devices, etc. In various embodiments, computing devices 101A-B can be, can include, or can be included in a computer system such as computer system 500 of FIG. 5. For example, computing device 101A can be a personal computer (PC), a laptop computer, a notebook computer, a mobile phone, a smartphone, a tablet computer, a digital assistant, a rackmount server, a router computer, or similar computing device. In other examples, computing device 101A can be a network interface controller (NIC), data processing unit (DPU), graphics processing unit (GPU), central processing unit (CPU), system on chip (SoC), a switch device (e.g., a network switch), or similar.

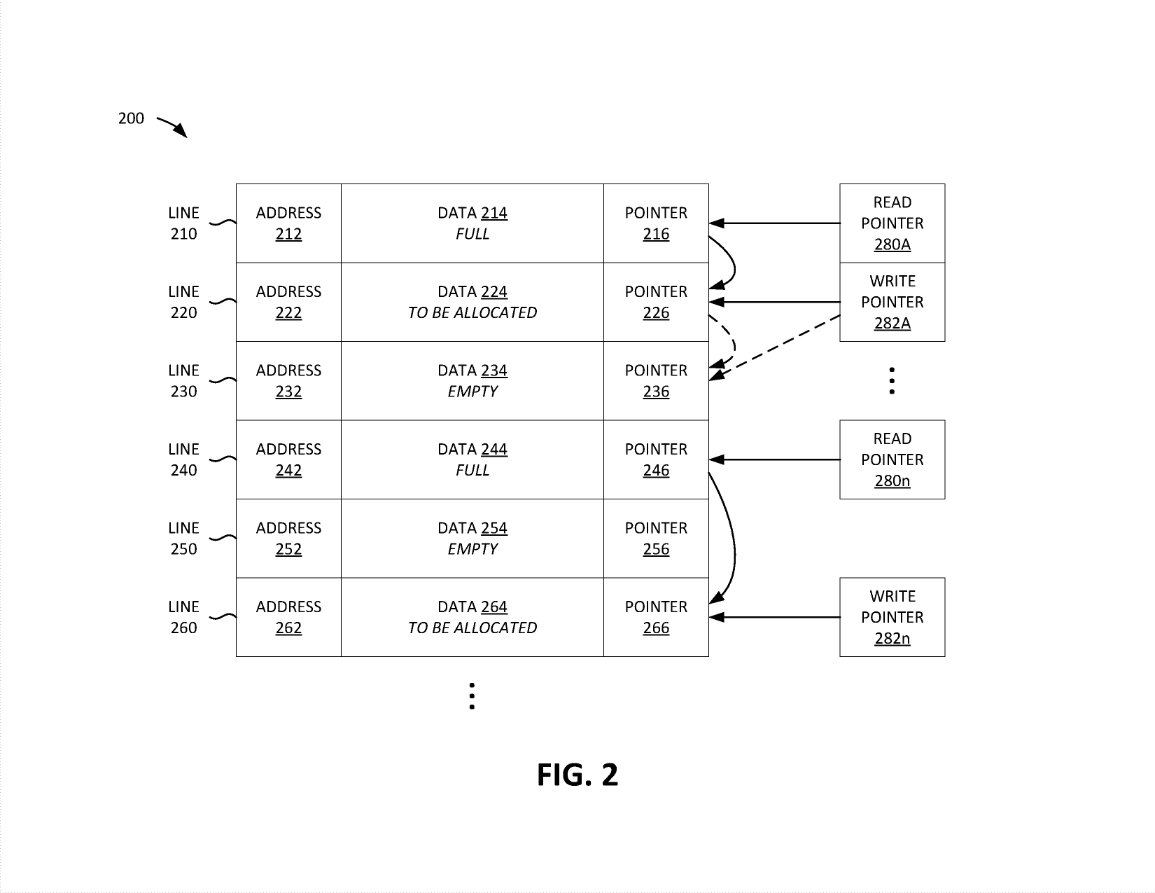

Digital interface controller 106A includes transmitter 107A, receiver 108A, and buffer 200A. Transmitter 107A transmits packet data via link 109 to computing device 101B, and receiver 108A receives packet data (e.g., input packet data 102) via link 109 from computing device 101B. Receiver 108A can buffer input packet data 102 in buffer 200 and provide output packet data 104 to other components of computing device 101A (e.g., processor 103A, memory 105A). Receiver 108A and buffer 200A are further described with reference to FIGS. 1B-2. In an embodiment, digital interface controller 106A can be or can be included in a NIC, DPU, GPU, CPU, SoC, switch device, or similar.

FIG. 1B is a block diagram of an example digital interface controller architecture 106A for providing virtual channel packet processing in digital interfaces, in accordance with an embodiment. Digital interface controller architecture 106A (also referred to as “system” herein) includes buffer management components for digital interface receiver 110, including packet preprocessor 112, input accumulators 114A-n, output accumulators 116A-n, packet postprocessor 118, and receiver buffer manager 120. System 110A further includes buffer 200, which is further described with reference to FIG. 2. Other components of digital interface controller 106A are omitted for clarity (e.g., transmitter 107A). In various embodiments, system 106A can have more or fewer components than those depicted in FIG. 1B. For example, system 106A can include additional receivers and associated components (e.g., as described with reference to FIG. 1C). In another example, packet preprocessor 112 and/or packet postprocessor 118 can be absent.

Digital interface receiver 110 can correspond to a link between two or more devices, such as a PCIe link or similar. A computing device can include a receiver to receive data on digital interface receiver 110, which can include the buffer management system components depicted in digital interface receiver 110. Input packet data 102 can correspond to data received on digital interface receiver 110, and output packet data 104 can correspond to the same data when the computing device is ready to process the data (e.g., after being buffered in system 106A). In an embodiment as described with reference to FIG. 1C, a computing device can support multiple receivers and can share buffer management components between receivers or can have duplicate buffer management components for each link/receiver.

Packet preprocessor 112 can perform one or more preprocessing functions on input packet data 102. For example, packet preprocessor 112 can check packet integrity (e.g., cyclic redundancy check), reject malformed packets, or similar. In various embodiments, packet preprocessor 112 can be absent or can include subcomponents for each preprocessing function. Packet preprocessor can forward input packet data 102 (or modified version thereof) to an input accumulator of input accumulators 114A-n.

Input accumulators 114A-n can temporarily store packet data associated with packet characteristics. A packet characteristic can include a packet virtual channel (e.g., PCIe VC0-VC7), a packet type (e.g., P, NP, Cpl types), or similar. Each input accumulator of input accumulators 114A-n can correspond to a specific packet characteristic or combination of packet characteristics. For example, input accumulator 114A can correspond to VC0, 114B to VC1, etc. In another example, input accumulator 114A can correspond to P-type packets for VC0, 114B to NP-type packets for VC1, etc. In an embodiment with multiple receivers as described with reference to FIG. 1B, the originating link of a packet can be a packet characteristic.

Each input accumulator of input accumulators 114A-n can have a data width characteristic representing how many units (e.g., bits, bytes, words) of packet data can be accumulated. In various embodiments, input accumulators 114A-n can all have the same data width or different data widths. In an embodiment, each input accumulator of input accumulators 114A-n can accumulate multiple data widths’ worth of packet data, such as in a ring buffer or double buffer structure. In an embodiment, the data width of input accumulators 114A-n is greater than or equal to a data width of a line of buffer 200 as described below.

Output accumulators 116A-n can store packet data associated with packet characteristics as described with reference to input accumulators 114A-n above. In an embodiment, each output accumulator corresponds to a respective input accumulator and vice versa. Output accumulators 116A-n can similarly have a data width characteristic, which can be the same or different than the data width(s) of input accumulators 114A-n. In an embodiment, as above, each output accumulator of output accumulators 116A-n can accumulate multiple data widths’ worth of packet data. Accumulated packet data can be forwarded to packet postprocessor 118.

Packet postprocessor 118 can perform one or more postprocessing functions to generate output packet data 104. For example, packet postprocessor 118 can arbitrate with a receiving component of a computing system (not depicted) to deliver output packet data 104. In various embodiments, packet postprocessor 118 can be absent or can include subcomponents for each postprocessing function.

In an embodiment, input accumulators 114A-n, output accumulators 116A-n, and/or buffer 200 can correspond to memory allocated by a host device operationally coupled to the buffer management system. For example, the memory can be allocated by computing device 101A (e.g., a CPU, DPU, GPU, switch, etc.).

Receiver buffer manager 120 communicates with input accumulators 114A-n, output accumulators 116A-n, and buffer 200 to receive, buffer, and forward packet data for receiver 110. Receiver buffer manager 120 includes input accumulator controller 122, buffer write controller 124, buffer read controller 126, output accumulator controller 128, and bypass controller 130. In various embodiments, receiver buffer manager 120 can include more, fewer, or different components than those depicted in FIG. 1A.

Input accumulator controller 122 communicates with and receives data from input accumulators 114A-n using signals 132A-n, 134A-n, and other signals not depicted. For example, one of signals 132A-n can indicate to input accumulator controller 122 when one or more data widths’ worth of packet data has been accumulated in input accumulator 114A. Another signal from input accumulator controller 122 can instruct input accumulator 114A to forward one or more data widths’ worth of accumulated packet data. Another signal from input accumulator 114A can contain the accumulated packet data. In an embodiment, input accumulator controller 122 obtains packet data from input accumulator 114A when a threshold quantity of packet data (e.g., one or more data widths) has been accumulated in input accumulator 114A.

Similarly, output accumulator controller 128 communicates with and provides data to output accumulators 116A-n using signals 136A-n, 138A-n, and other signals not depicted. For example, one of signals 136A-n can indicate to output accumulator controller 128 when output accumulator 116A is ready to accept one or more data widths’ worth of packet data. Another signal from output accumulator controller 128 can contain the packet data to be accumulated in output accumulator 116A. In an embodiment, output accumulator controller 128 stores packet data in output accumulator 116A when a threshold capacity of packet data storage (e.g., one or more data widths) is available in output accumulator 116A.

Receiver buffer manager 120 can determine to store the packet data obtained from input accumulator 114A in buffer 200 or immediately forward the packet data to output accumulator 116A. In an example of the former case, receiver buffer manager 120 can determine (e.g., using output accumulator controller 128) that a threshold capacity is unavailable in output accumulator 116A and thus that the packet data is to be buffered in buffer 200. In another example of the former case, receiver buffer manager 120 can determine (e.g., using buffer read controller 126) that additional packet data associated with the same packet characteristic(s) as the obtained packet data is stored in buffer 200 and is pending transfer to output accumulator 116A, and thus that the packet data is to be buffered in buffer 200 (e.g., after the additional packet data).

To store the obtained packet data in buffer 200, input accumulator controller 122 can forward the packet data to buffer write controller 124, which can write the packet data to a line of buffer 200. In an embodiment, buffer write controller 124 uses a write pointer associated with the packet characteristic(s) of the packet data to write the packet data to a line of buffer 200, as described with reference to FIG. 2.

Once receiver buffer manager 120 determines (e.g., using output accumulator controller 128) that a threshold capacity is available in output accumulator 116A, buffer read controller 126 can read the next available packet data from a line of buffer 200 and forward the packet data to output accumulator controller 128 for storing in output accumulator 116A. In an embodiment, buffer read controller 126 uses a read pointer associated with the packet characteristic(s) of the packet data to read the packet data from a line of buffer 200, as described with reference to FIG. 2.

Receiver buffer manager 120 can alternatively determine to immediately forward the packet data obtained from input accumulator 114A to output accumulator 116A, bypassing buffer 200. For example, upon receiving packet data at input accumulator controller 122, receiver buffer manager 120 can determine (e.g., using output accumulator controller 128) that a threshold capacity is available in output accumulator 116A and thus that the packet data is to be immediately forwarded. Bypass controller 130 can thus forward the packet data from input accumulator controller 122 to output accumulator controller 128.

In contrast to input accumulators 114A-n and output accumulators 116A, each of which can be dedicated to a specific packet characteristic(s), buffer 200 can be a shared buffer that stores packet data associated with any packet characteristic(s). The example buffer 200 described with reference to FIG. 2 includes components for enabling shared packet data buffering. In an embodiment, system 106A can include multiple buffers 200 (not depicted), each dedicated to a single packet characteristic or a subset of packet characteristics.

FIG. 1C is a block diagram of an example digital interface controller architecture 106C for providing virtual channel packet processing in digital interfaces, in accordance with an embodiment. System architecture 106C (also referred to as “system” herein) includes buffer management components for digital interface receivers 110A-n. Buffer management components are omitted in FIG. 1C but can be the same as or similar to those depicted in FIG. 1B for receiver 110 (e.g., including packet preprocessor 112, input accumulators 114A-n, output accumulators 116A-n, packet postprocessor 118, and receiver buffer manager 120). System 1106C further includes buffer 200, which is further described with reference to FIG. 2. In various embodiments, system 106C can have more or fewer components than those depicted in FIG. 1C. For example, system 106C can include additional buffers.

As depicted in FIG. 1C, each of receivers 110A-n can be associated with respective input packet data 120A-n and output packet data 104A-n. In an embodiment, the link with which a packet is associated can be a type of packet characteristic as described with reference to FIG. 1B. Buffer 200 is connected to the buffer management components of each receiver (e.g., respective buffer read/write controllers of each receiver) and can be used to buffer input packet data 102A-n. Buffer 200 can include respective read and write pointers for each of receivers 110A-n. Read and write pointers are further described with reference to FIG. 2. In an embodiment, additional buffers 200 can be present, each serving a single receiver or a subset of receivers 110A-n.

FIG. 2 is a block diagram of an example buffer 200 for providing virtual channel packet processing in digital interfaces, in accordance with an embodiment. Buffer 200 includes multiple buffer lines, of which lines 210-260 are depicted as examples. Buffer 200 further includes read pointers 280A-n and write pointers 282A-n. In various embodiments, buffer 200 can have more or fewer components than those depicted in FIG. 2. For example, buffer 200 can have a single pair of read and write buffers.

Each of lines 210-260 includes an address (addresses 212-262), a data buffer (data buffers 214-264), and pointer metadata (pointer metadata 216-266). Each data buffer of data buffers 214-264 can be associated with a data width (e.g., the amount of data that can be stored in the data buffer), which can correspond to one or more of the various data widths described with reference to FIG. 1A. For example, a data width of data buffer 214 can be equal to a data width of input accumulator 114A, or the data width of input accumulator 114A can be a multiple of the data width of data buffer 214. Data buffers 214-264 can have the same data width or different data widths in various embodiments.

Read pointers 280A-n can each be associated with one or more packet characteristics, such as the packet characteristics described with reference to FIGS. 1A-B (e.g., virtual channel, packet type, link). In an embodiment, each of read pointers 280A-n corresponds to a respective input accumulator of input accumulators 114A-n and a respective output accumulator of output accumulators 116A-n, and vice versa. For example, read pointer 280A can be associated with the same packet characteristic(s) as input accumulator 114A and output accumulator 116A. Similarly, write pointers 282A-n can be associated with one or more packet characteristics and can correspond to respective input accumulators and output accumulators. Each write pointer of write pointers 282A-n can be paired with a respective read pointer of read pointers 280A-n.

Each pair of read pointers and write pointers (e.g., pair 280A-282A) can be used to form a linked list of buffered packet data corresponding to one or more packet characteristics. In an illustrative example, read pointer 280A and write pointer 282A can correspond to packets of PCIe virtual channel VC0. When buffer write controller 124 of FIG. 1 receives packet data to store in buffer 200, buffer write controller 124 can obtain the next write position from write pointer 282A. Write pointer 282A can initially point to line 220. The present value of write pointer 282A (line 220) can also be stored in a previously written line (line 210) as pointer metadata 216 to form a link in the linked list. Buffer write controller 124 can store the packet data in data buffer 224 of line 220. Subsequently, buffer write controller 124 can set write pointer 282A to point to the next available line (line 230), and buffer write controller 124 can also store the updated write pointer in the newly written line (line 220) as pointer metadata 226. These updated pointers are indicated in dashed lines in FIG. 2. Buffer read controller 126 can obtain the next packet data in buffer 200 associated with the same characteristic using read pointer 280A to identify line 210. Subsequent to reading the packet data in line 210, buffer read controller 126 can update read pointer 280A to point to the next line indicated by pointer metadata 216 (line 220) and deallocate line 210. Similarly, read and write pointers 280n-282n can be used to form a linked list for packets of PCIe virtual channel VC1. Each of lines 210-260 can be used to store packet data for either VC0 or VC1. For example, when line 210 storing packet data for VC0 is read and deallocated, it can be subsequently allocated to store packet data for VC1. Thus, the total size of buffer 200 can be reduced by sharing lines, and fragmentation can be avoided due to the fixed data width of each line and the separate linked lists.

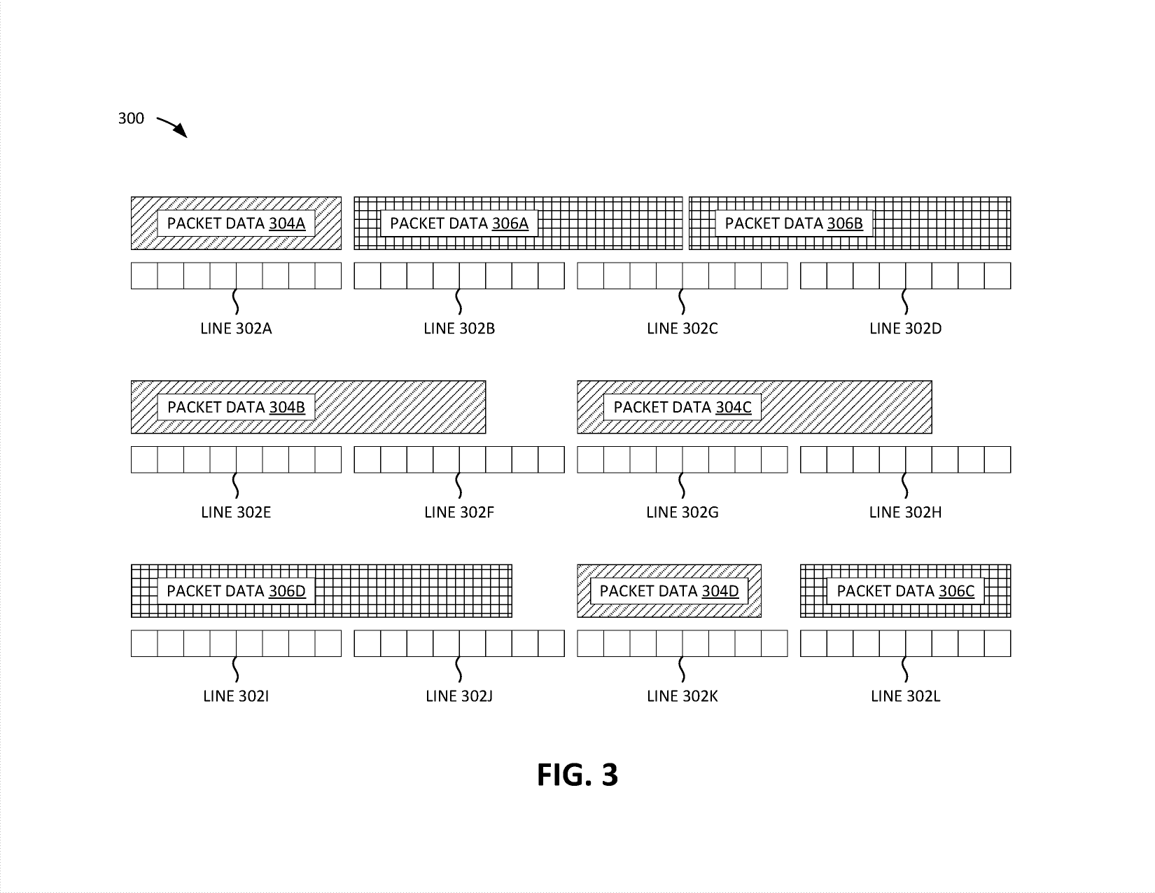

FIG. 3 is a block diagram of an example mapping 300 between packet data and buffer lines, in accordance with an embodiment. Mapping 300 includes lines 302A-L, packet data 304A-D, and packet data 306A-D. Lines 302A-L can correspond to lines 210-260 of FIG. 2. Packet data 304A-D and 306A-D can correspond to input packet data 102 of FIG. 1A. Packet data 304A-D can be associated with a first packet characteristic (e.g., VC0), and packet data 306A-D can be associated with a second packet characteristic (e.g., VC1).

Each of lines 302A-L has a fixed data width, illustrated in FIG. 3 as eight units (e.g., bits, bytes, words, etc.). In contrast, packet data 304A-D and 306A-D can have variable data widths, which can lead to fragmentation problems and inefficient use of buffer space, as previously described. To mitigate these problems, the variable width packet data can be mapped to the fixed width lines of a buffer. FIG. 3 illustrates example mapping variations. The illustrated mapping variations may or may not be simultaneously present in the same embodiment.

In an embodiment, packet data can occupy a single line, such as packet data 304A, 304D, and 306D. In an embodiment, packet data can be spread across multiple lines, such as packet data 306A, 306B, 304B, 304C, and 306C. Various embodiments can include combinations of single-line and multi-line packet mappings.

In an embodiment, packet data of a first characteristic can be interleaved between packet data of a second characteristic. For example, packet data 306A-B in lines 302B-D are interleaved between packet data 304A and 304B in lines 302A and 302E. In another example, packet data 304D in line 302K is interleaved between packet data 306D and 306C in lines 302J and 302L. Interleaving packets can result from the order in which packets of differing characteristics are received at the buffer management system. For example, a packet of a first characteristic can be received, followed by an interleaving packet of a second characteristic, followed by a packet of the first characteristic. Interleaving packets can also result from the order in which buffer lines are freed and allocated. For example, a line can initially store a packet of a first characteristic, and after that packet is read out, can subsequently be reallocated to store a packet of a second characteristic, forming an interleaving set of packets. This example further illustrates that packets of the same characteristic need not be stored in ascending order (e.g., packet 306D was written after packet 306C but is stored ahead of packet 306C in lines 302I-J).

In an embodiment, buffer lines can be dedicated to storing packet data of a single packet. For example, lines 302-B and 302D-L each store packet data of a single packet. Some lines are fully utilized (e.g., lines 302A-B, 302D-E, 302G, 302I, and 302L), while other lines are partially utilized (e.g., lines 302F, 302H, 302J, and 302K). Buffer lines dedicated to packet data of single packets can be advantageous because buffer read and write operations need not account for multiple packets in a single line. In an embodiment, buffer lines can store packet data of multiple packets. For example, line 302C stores packet data of packets 306A-B. Line 302C is thus fully utilized, which can be an advantage of buffer lines that can store packet data of multiple packets.

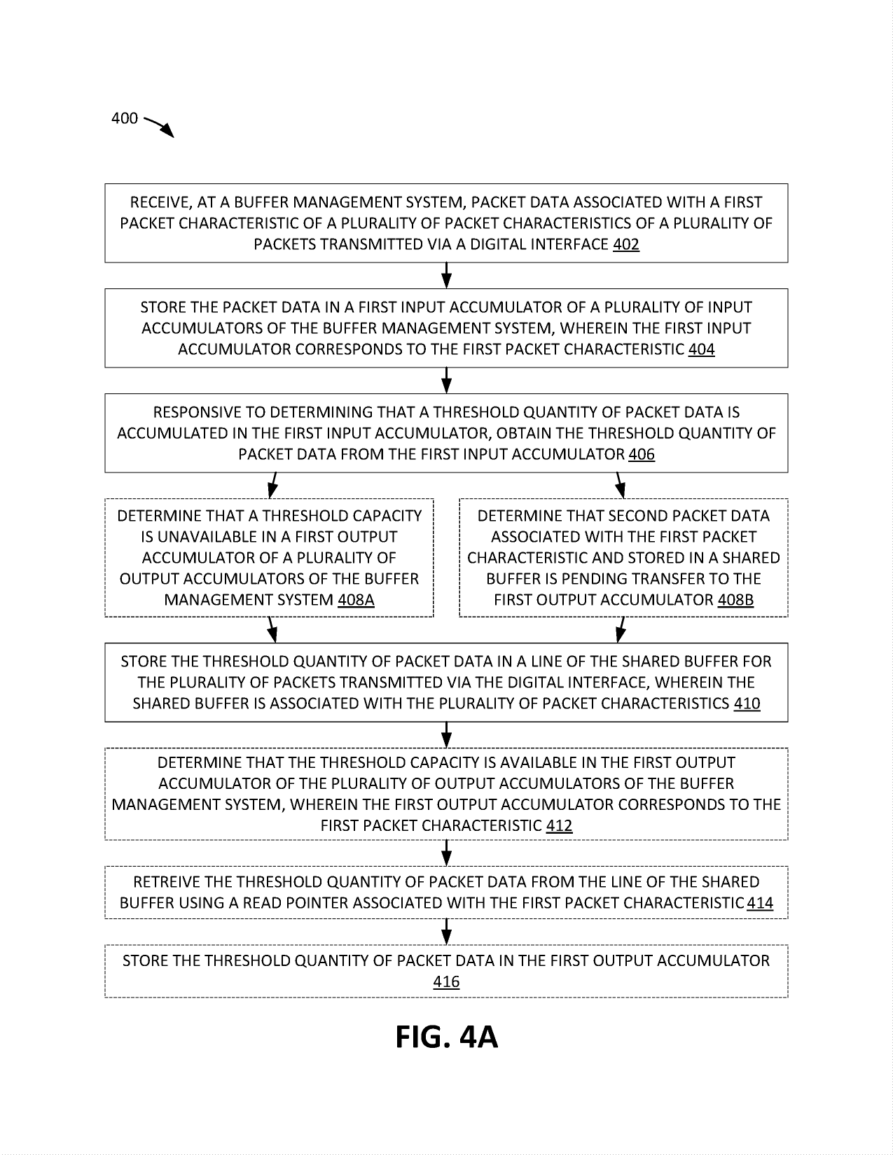

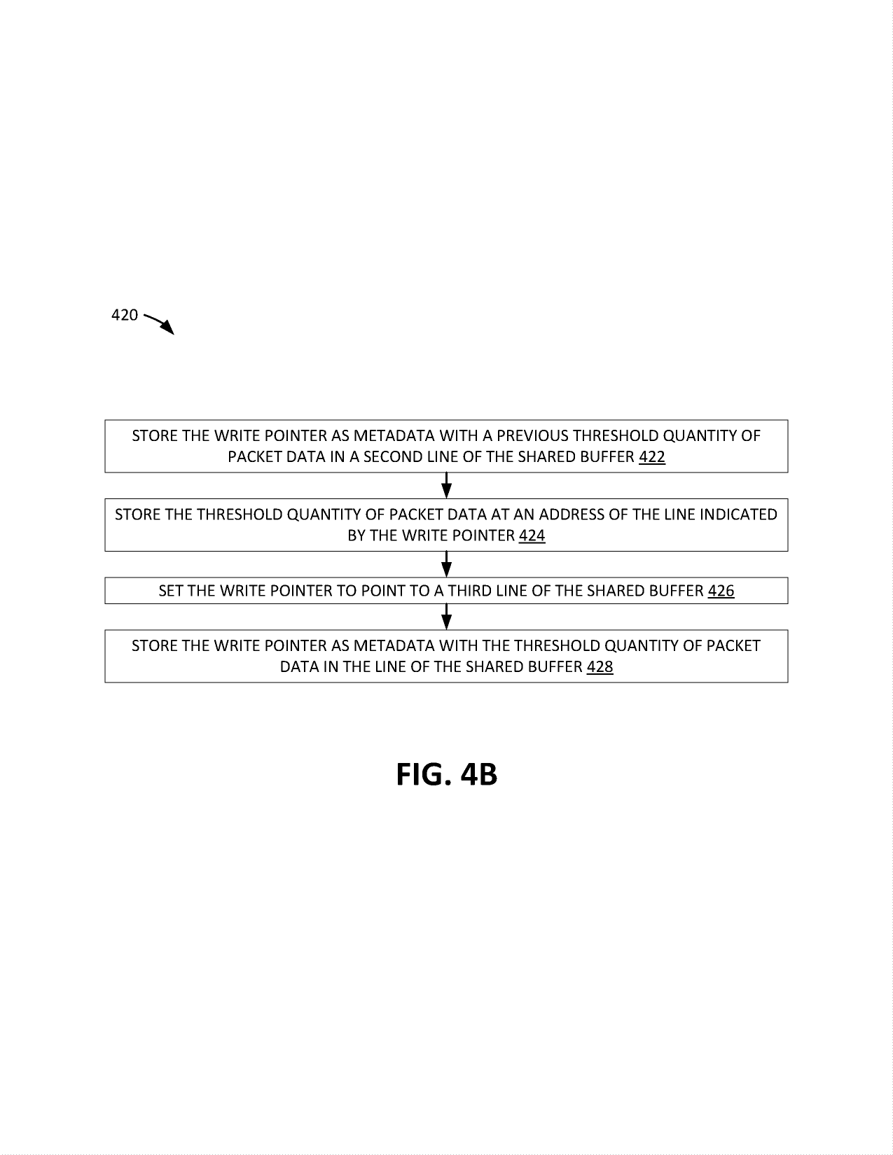

FIG. 4A is a flow diagram of an example method 400 for providing virtual channel packet processing in digital interfaces, in accordance with an embodiment. Method 400 can be performed by processing logic that can include hardware (e.g., circuitry, dedicated logic, etc.), computer-readable instructions such as software or firmware (e.g., run on a general-purpose computing system or a dedicated machine), or a combination thereof. For instance, an example system can include a memory and a processing device coupled to the memory device to perform operations comprising the blocks of method 400. Method 400 can also be associated with a set of instructions stored on a non-transitory computer-readable medium (e.g., magnetic or optical disk, etc.). The instructions, when executed by a processing device, can cause the processing device to perform operations comprising the blocks of method 400. In an embodiment, method 400 is performed by the systems of FIGS. 1A-B or components thereof (e.g., receiver buffer manager 120, input accumulator controller 122, buffer write controller 124, etc.). In an embodiment, method 400 is performed by computing system 500 of FIG. 5. In some embodiments, blocks depicted in FIG. 4A could be performed simultaneously or in a different order than depicted. Various embodiments can include additional blocks not depicted in FIG. 4A or a subset of blocks depicted in FIG. 4A. For example, blocks depicted with dashed outlines in FIG. 4A (e.g., blocks 408A-B and 412-416) can be absent in an embodiment.

At block 402, processing logic of a buffer management system receives packet data associated with a first packet characteristic of a plurality of packet characteristics of a plurality of packets transmitted via a digital interface. The buffer management system can be system 100 or 106A of FIG. 1. The packet data can be input packet data 102 of FIG. 1A or packet data 304A-D or 306A-D of FIG. 3. The packet data can be transmitted via a PCIe interface or other type of digital interface.

In an embodiment, the plurality of packet characteristics corresponds to a plurality of virtual channels of the digital interface. For example, the plurality of packet characteristics can correspond to PCIe virtual channels VC0-VC7, and the received packet data associated with the first packet characteristic can be packet data received from one of the virtual channels (e.g., VC3). In an embodiment, the plurality of packet characteristics corresponds to posted, non-posted, and completion packet types of the digital interface (e.g., of a PCIe interface). The received packet data associated with the first packet characteristic can be packet data annotated with one of the above packet types. Other embodiments can include packet types other than posted, non-posted, and completion packet types. In an embodiment, the received packet data can be associated with one or more packet characteristics (e.g., second packet characteristic, third packet characteristic, etc.), each packet characteristic corresponding to respective pluralities of packet characteristics. For example, received packet data can be associated with a virtual channel of a plurality of virtual channels and a packet type of a plurality of packet types.

At block 404, the processing logic stores the packet data in a first input accumulator of a plurality of input accumulators of the buffer management system, wherein the first input accumulator corresponds to the first packet characteristic. The plurality of input accumulators can correspond to input accumulators 114A-n of FIG. 1A. In an embodiment, each of the plurality of input accumulators corresponds to one or more packet characteristics such as a channel of a plurality of virtual channels, a packet type of a plurality of packet types, and/or others. Each packet characteristic can in turn be associated with a single respective input accumulator or multiple respective input accumulators.

In an embodiment, a data width of the first input accumulator is greater than or equal to a data width of a line of a shared buffer (e.g., buffer 200 of FIG. 1). In an embodiment, the data width of the first input accumulator is an integer multiple (e.g., 2x, 3x, etc.) or fractional multiple (e.g., 0.5x, 1.5x) of the data width of the line of the shared buffer. The data width of the first input accumulator can be associated with other data width values of the buffer management system in various embodiments. In various embodiments, other input accumulators of the plurality of input accumulators can have the same data width as the first input accumulator or different data widths.

At block 406, responsive to determining that a threshold quantity of packet data is accumulated in the first input accumulator, the processing logic obtains the threshold quantity of packet data from the first input accumulator. In an embodiment, the determination can be signaled via signals 132A-n of FIG. 1A, and the threshold quantity of packet data can be obtained from the first input accumulator by input accumulator controller 122. In various embodiments, the threshold quantity of packet data is equal to a data width of a line of a shared buffer, a data width of the first input accumulator, or multiples or fractions thereof.

At block 408A, the processing logic determines that the threshold capacity is unavailable in a first output accumulator of a plurality of output accumulators of the buffer management system. The plurality of output accumulators can correspond to output accumulators 1xxA-n of FIG. 1A.

At block 408B, the processing logic determines that second packet data associated with the first packet characteristic and stored in a shared buffer is pending transfer to the first output accumulator. The shared buffer can correspond to buffer 200 of FIG. 1A, and the second packet data can correspond to packet data 304A or 306A of FIG. 3.

At block 410, the processing logic stores the threshold quantity of packet data in a line of the shared buffer for the plurality of packets transmitted via the digital interface, wherein the shared buffer is associated with the plurality of packet characteristics (e.g., the shared buffer stores packet data for each packet characteristic of the plurality of packet characteristics). The line of the shared buffer can be line 220 of FIG. 2. In an embodiment, the shared buffer is one of a plurality of shared buffers, each associated with a subset of the plurality of packet characteristics (e.g., the shared buffer stores packet data for a subset of packet characteristics of the plurality of packet characteristics).

In an embodiment, the threshold quantity of packet data is stored in the line of the shared buffer using a write pointer associated with the first packet characteristic. The write pointer can correspond to write pointer 282A of FIG. 2. In an embodiment, the write pointer is associated with a linked list corresponding to the first packet characteristic. An example method for storing the threshold quantity of packet data in the shared buffer using a write pointer is further described with reference to FIG. 4B and method 420.

At block 412, the processing logic determines that the threshold capacity is available in the first output accumulator of the plurality of output accumulators of the buffer management system, wherein the first output accumulator corresponds to the first packet characteristic. In an embodiment, each of the plurality of output accumulators corresponds to one or more packet characteristics such as a channel of a plurality of virtual channels, a packet type of a plurality of packet types, and/or others. Each packet characteristic can in turn be associated with a single respective output accumulator or multiple respective output accumulators.

In an embodiment, a data width of the first output accumulator is greater than or equal to a data width of a line of the shared buffer. In an embodiment, the data width of the first output accumulator is an integer multiple (e.g., 2x, 3x, etc.) or fractional multiple (e.g., 0.5x, 1.5x) of the data width of the line of the shared buffer. The data width of the first output accumulator can be associated with other data width values of the buffer management system in various embodiments. In various embodiments, other output accumulators of the plurality of output accumulators can have the same data width as the first output accumulator or different data widths. In various embodiments, the threshold capacity is equal to a data width of a line of a shared buffer, a data width of the first output accumulator, or multiples or fractions thereof.

At block 414, the processing logic retrieves the threshold quantity of packet data from the line of the shared buffer using a read pointer associated with the first characteristic. The read pointer can correspond to read pointer 280A of FIG. 2.

At block 416, the processing logic stores the threshold quantity of packet data in the first output accumulator.

FIG. 4B is a flow diagram of an example method 420 for providing storing a threshold quantity of packet data in a shared buffer using a write pointer, in accordance with an embodiment. Method 420 can be performed by processing logic that can include hardware (e.g., circuitry, dedicated logic, etc.), computer-readable instructions such as software or firmware (e.g., run on a general-purpose computing system or a dedicated machine), or a combination thereof. For instance, an example system can include a memory and a processing device coupled to the memory device to perform operations comprising the blocks of method 420. Method 420 can also be associated with a set of instructions stored on a non-transitory computer-readable medium (e.g., magnetic or optical disk, etc.). The instructions, when executed by a processing device, can cause the processing device to perform operations comprising the blocks of method 420. In an embodiment, method 420 is performed by the systems of FIGS. 1A-B or components thereof (e.g., receiver buffer manager 120, input accumulator controller 122, buffer write controller 124, etc.). In an embodiment, method 420 is performed by computing system 500 of FIG. 5. In some embodiments, blocks depicted in FIG. 4B could be performed simultaneously or in a different order than depicted. Various embodiments can include additional blocks not depicted in FIG. 4B or a subset of blocks depicted in FIG. 4B. In an embodiment, method 420 is used to perform block 410 of FIG. 4A, where the threshold quantity of packet data is stored in the line of the shared buffer using a write pointer associated with the first packet characteristic and the write pointer is associated with a linked list corresponding to the first packet characteristic.

At block 422, processing logic of a buffer management system stores the write pointer as metadata with a previous threshold quantity of packet data in a second line of the shared buffer. The previous threshold quantity of packet data in the second line of the shared buffer can correspond to line 210 of FIG. 2.

At block 424, the processing logic stores the threshold quantity of packet data at an address of the line indicated by the write pointer. The line indicated by the write pointer can be line 220 of FIG. 2 with address 222.

At block 426, the processing logic sets the write pointer to point to a third line of the shared buffer. The third line can be line 230 of FIG. 2.

At block 428, the processing logic stores the write pointer as metadata with the threshold quantity of packet data in the line of the shared buffer. The metadata can correspond to pointer metadata 226 of FIG. 2.

FIG. 5 is a block diagram illustrating an exemplary computer system, which may be a system with interconnected devices and components, a system-on-a-chip (SOC) or some combination thereof 500 formed with a processor that may include execution units to execute an instruction, according to at least one embodiment. In at least one embodiment, computer system 500 may include, without limitation, a component, such as a processor 502 to employ execution units including logic to perform algorithms for process data, in accordance with present disclosure, such as in embodiment described herein. In at least one embodiment, computer system 500 may include processors, such as PENTIUM® Processor family, XeonTM, Itanium®, XScaleTM and/or StrongARMTM, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 500 may execute a version of WINDOWS’ operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, edge devices, Internet-of-Things (“IoT”) devices, or any other system that may perform one or more instructions in accordance with at least one embodiment.

In at least one embodiment, computer system 500 may include, without limitation, processor 502 that may include, without limitation, one or more execution units 508 to perform machine learning model training and/or inferencing according to techniques described herein. In at least one embodiment, computer system 500 is a single processor desktop or server system, but in another embodiment computer system 500 may be a multiprocessor system. In at least one embodiment, processor 502 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 502 may be coupled to a processor bus 510 that may transmit data signals between processor 502 and other components in computer system 500.

In at least one embodiment, processor 502 may include, without limitation, a Level 1 (“L1”) internal cache memory (“cache”) 504. In at least one embodiment, processor 502 may have a single internal cache or multiple levels of internal cache. In at least one embodiment, cache memory may reside external to processor 502. Other embodiments may also include a combination of both internal and external caches depending on particular implementation and needs. In at least one embodiment, register file 506 may store different types of data in various registers including, without limitation, integer registers, floating point registers, status registers, and instruction pointer register.

In at least one embodiment, execution unit 508, including, without limitation, logic to perform integer and floating-point operations, also resides in processor 502. In at least one embodiment, processor 502 may also include a microcode (“ucode”) read-only memory (“ROM”) that stores microcode for certain macro instructions. In at least one embodiment, execution unit 508 may include logic to handle a packed instruction set 509. In at least one embodiment, by including packed instruction set 509 in an instruction set of a general-purpose processor 502, along with associated circuitry to execute instructions, operations used by many multimedia applications may be performed using packed data in a general-purpose processor 502. In one or more embodiments, many multimedia applications may be accelerated and executed more efficiently by using full width of a processor’s data bus for performing operations on packed data, which may eliminate need to transfer smaller units of data across processor's data bus to perform one or more operations one data element at a time.

In at least one embodiment, execution unit 508 may also be used in microcontrollers, embedded processors, graphics devices, DSPs, and other types of logic circuits. In at least one embodiment, computer system 500 may include, without limitation, a memory 520. In at least one embodiment, memory 520 may be implemented as a Dynamic Random Access Memory (“DRAM”) device, a Static Random Access Memory (“SRAM”) device, flash memory device, or other memory device. In at least one embodiment, memory 520 may store instruction(s) 519 and/or data 521 represented by data signals that may be executed by processor 502.

In at least one embodiment, system logic chip may be coupled to processor bus 510 and memory 520. In at least one embodiment, system logic chip may include, without limitation, a memory controller hub (“MCH”) 516, and processor 502 may communicate with MCH 516 via processor bus 510. In at least one embodiment, MCH 516 may provide a high bandwidth memory path 518 to memory 520 for instruction and data storage and for storage of graphics commands, data and textures. In at least one embodiment, MCH 516 may direct data signals between processor 502, memory 520, and other components in computer system 500 and to bridge data signals between processor bus 510, memory 520, and a system I/O 522. In at least one embodiment, system logic chip may provide a graphics port for coupling to a graphics controller. In at least one embodiment, MCH 516 may be coupled to memory 520 through a high bandwidth memory path 518 and graphics/video card 512 may be coupled to MCH 516 through an Accelerated Graphics Port (“AGP”) interconnect 514.

In at least one embodiment, computer system 500 may use system I/O 522 that is a proprietary hub interface bus to couple MCH 516 to I/O controller hub (“ICH”) 530. In at least one embodiment, ICH 530 may provide direct connections to some I/O devices via a local I/O bus. In at least one embodiment, local I/O bus may include, without limitation, a high-speed I/O bus for connecting peripherals to memory 520, chipset, and processor 502. Examples may include, without limitation, an audio controller 529, a firmware hub (“flash BIOS”) 528, a wireless transceiver 526, a data storage 524, a legacy I/O controller 523 containing user input and keyboard interfaces 525, a serial expansion port 527, such as Universal Serial Bus (“USB”), and a network controller 534, which may include in some embodiments, a data processing unit. Data storage 524 may comprise a hard disk drive, a floppy disk drive, a CD-ROM device, a flash memory device, or other mass storage device.

In at least one embodiment, FIG. 5 illustrates a system, which includes interconnected hardware devices or “chips,” whereas in other embodiments, FIG. 5 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 500 are interconnected using compute express link (CXL) interconnects.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items but may be more when so indicated either explicitly or by context. Further, unless stated otherwise or otherwise clear from context, phrase “based on” means “based at least in part on” and not “based solely on.”

Operations of processes described herein may be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors - for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system’s registers and/or memories into other data similarly represented as physical quantities within computing system’s memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data may be accomplished in a variety of ways such as by receiving data as a parameter of a function call or a call to an application programming interface. In some implementations, process of obtaining, acquiring, receiving, or inputting analog or digital data may be accomplished by transferring data via a serial or parallel interface. In another implementation, process of obtaining, acquiring, receiving, or inputting analog or digital data may be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data may be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
receiving, at a buffer management system, packet data associated with a first packet characteristic of a plurality of packet characteristics of a plurality of packets transmitted via a digital interface;
storing the packet data in a first input accumulator of a plurality of input accumulators of the buffer management system, wherein the first input accumulator corresponds to the first packet characteristic;
responsive to determining that a threshold quantity of packet data is accumulated in the first input accumulator, obtaining the threshold quantity of packet data from the first input accumulator; and
storing the threshold quantity of packet data in a line of a shared buffer for the plurality of packets transmitted via the digital interface, wherein the shared buffer is associated with the plurality of packet characteristics.

2. The method of claim 1, wherein the plurality of packet characteristics corresponds to a plurality of virtual channels of the digital interface.

3. The method of claim 1, wherein the plurality of packet characteristics corresponds to posted, non-posted, and completion packet types of the digital interface.

4. The method of claim 1, wherein a data width of the first input accumulator is greater than or equal to a data width of the line of the shared buffer.

5. The method of claim 1, wherein the threshold quantity of packet data is stored in the line of the shared buffer using a write pointer associated with the first packet characteristic.

6. The method of claim 5, wherein the write pointer is associated with a linked list corresponding to the first packet characteristic, and wherein storing the threshold quantity of packet data comprises:
storing the write pointer as metadata with a previous threshold quantity of packet data in a second line of the shared buffer;
storing the threshold quantity of packet data at an address of the line indicated by the write pointer;
setting the write pointer to point to a third line of the shared buffer; and
storing the write pointer as metadata with the threshold quantity of packet data in the line of the shared buffer.

7. The method of claim 1, further comprising:
determining that a threshold capacity is available in a first output accumulator of a plurality of output accumulators of the buffer management system, wherein the first output accumulator corresponds to the first packet characteristic;
retrieving the threshold quantity of packet data from the line of the shared buffer using a read pointer associated with the first packet characteristic; and
storing the threshold quantity of packet data in the first output accumulator.

8. The method of claim 7, further comprising:
prior to storing the threshold quantity of packet data in the shared buffer, determining that the threshold capacity is unavailable in the first output accumulator of the plurality of output accumulators of the buffer management system.

9. The method of claim 7, further comprising:
prior to storing the threshold quantity of packet data in the shared buffer, determining that second packet data associated with the first packet characteristic and stored in the shared buffer is pending transfer to the first output accumulator.

10. A system comprising:
a memory device; and
a processing device coupled to the memory device, the processing device to perform operations comprising:
receiving, at a buffer management system, packet data associated with a first packet characteristic of a plurality of packet characteristics of a plurality of packets transmitted via a digital interface;
storing the packet data in a first input accumulator of a plurality of input accumulators of the buffer management system, wherein the first input accumulator corresponds to the first packet characteristic;
responsive to determining that a threshold quantity of packet data is accumulated in the first input accumulator, obtaining the threshold quantity of packet data from the first input accumulator; and
storing the threshold quantity of packet data in a line of a shared buffer for the plurality of packets transmitted via the digital interface, wherein the shared buffer is associated with the plurality of packet characteristics.

11. The system of claim 10, wherein the plurality of packet characteristics corresponds to a plurality of virtual channels of the digital interface.

12. The system of claim 10, wherein the plurality of packet characteristics corresponds to posted, non-posted, and completion packet types of the digital interface.

13. The system of claim 10, wherein a data width of the first input accumulator is greater than or equal to a data width of the line of the shared buffer.

14. The system of claim 10, wherein the threshold quantity of packet data is stored in the line of the shared buffer using a write pointer associated with the first packet characteristic.

15. The system of claim 14, wherein the write pointer is associated with a linked list corresponding to the first packet characteristic, and wherein storing the threshold quantity of packet data comprises:
storing the write pointer as metadata with a previous threshold quantity of packet data in a second line of the shared buffer;
storing the threshold quantity of packet data at an address of the line indicated by the write pointer;
setting the write pointer to point to a third line of the shared buffer; and
storing the write pointer as metadata with the threshold quantity of packet data in the line of the shared buffer.

16. A non-transitory computer-readable medium comprising instructions that, when executed by a processing device, cause the processing device to perform operations comprising:
receiving, at a buffer management system, packet data associated with a first packet characteristic of a plurality of packet characteristics of a plurality of packets transmitted via a digital interface;
storing the packet data in a first input accumulator of a plurality of input accumulators of the buffer management system, wherein the first input accumulator corresponds to the first packet characteristic;
responsive to determining that a threshold quantity of packet data is accumulated in the first input accumulator, obtaining the threshold quantity of packet data from the first input accumulator; and
storing the threshold quantity of packet data in a line of a shared buffer for the plurality of packets transmitted via the digital interface, wherein the shared buffer is associated with the plurality of packet characteristics.

17. The non-transitory computer-readable medium of claim 16, wherein the plurality of packet characteristics corresponds to a plurality of virtual channels of the digital interface.

18. The non-transitory computer-readable medium of claim 16, further comprising:
determining that a threshold capacity is available in a first output accumulator of a plurality of output accumulators of the buffer management system, wherein the first output accumulator corresponds to the first packet characteristic;
retrieving the threshold quantity of packet data from the line of the shared buffer using a read pointer associated with the first packet characteristic; and
storing the threshold quantity of packet data in the first output accumulator.

19. The non-transitory computer-readable medium of claim 18, further comprising:
prior to storing the threshold quantity of packet data in the shared buffer, determining that the threshold capacity is unavailable in the first output accumulator of the plurality of output accumulators of the buffer management system.

20. The non-transitory computer-readable medium of claim 18, further comprising:
prior to storing the threshold quantity of packet data in the shared buffer, determining that second packet data associated with the first packet characteristic and stored in the shared buffer is pending transfer to the first output accumulator.
